(19) United States
(12) Patent Application Publication
(10) Pub. No.: US 2004/0236778 A1
(43) Pub. Date: Nov. 25, 2004

(54) Mechanism for storing information about recorded television broadcasts

(75) Inventors: Jean-Claude Junqua, Santa Barbara, CA (US); Roland Kuhn, Santa Barbara, CA (US); Tony Davis, Santa Barbara, CA (US); Yi Zhao, Goleta, CA (US); Weiying Li, Montreal (CA)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC INDUSTRIAL CO., LTD., Osaka (JP)

(21) Appl. No.: 10/886,500

(22) Filed: Jul. 7, 2004

Related U.S. Application Data
(63) Continuation of application No. 09/383,759, filed on Aug. 26, 1999.

(51) Int. Cl. G06F 17/00

(52) U.S. Cl. 707/100

(57) ABSTRACT

Program content, recorded to a storage medium such as disk recorder, optical recorder or random access memory, is indexed by the replay file system. The file system maintains a storage location and program I.D. record for each recorded program. The file system further maintains other data obtained from an electronic program guide that may be accessed by downloading from the cable or satellite infrastructure or over the internet. The file system also may store additional user data, such as the date and time the program was last viewed, together with any user-recorded indexes. The file system may be accessed through natural language input speech. The system includes a speech recognizer and natural language parser, coupled to a dialog system that engages the user in a dialog to determine what the user is interested in accessing from the storage medium. The natural language parser operates with a task-based grammar that is keyed to the electronic program guide data and user data maintained by the file system.

### BACKGROUND AND SUMMARY OF THE INVENTION

The present invention relates generally to interactive television and interactive “replay” TV. More particularly, the invention relates to a speech-enabled system for automatically creating a catalog describing the contents of each TV owner's “library” of stored television broadcasts. The user interacts with the system by speaking complex, natural-language requests for information. The speech recognizer and natural-language parser of the system interpret the meaning of the user's requests and locate those recorded items in the owner's library that best respond to the request. In this way, a user can readily access any previously recorded information without the need for time consuming searching.

The system may also maintains a database of user-specific information, such as information about which recorded programs the user has accessed more recently (or never). This information may be used, for example, to suggest to the user which recorded programs may be deleted when the capacity of the recording device is near full.

For a more complete understanding of the invention, its objects and advantages, refer to the following specification and to the accompanying drawings.

### BRIEF DESCRIPTION OF THE DRAWINGS

FIG. 1 is a system block diagram of the system for storing information about recorded broadcasts, illustrating the presently preferred file system structure;

FIG. 2 is a block diagram depicting the components of the natural language parser of the presently preferred embodiment of the invention; and

FIG. 3 is a block diagram depicting the components of the local parser of the presently preferred embodiment of the invention.

### DESCRIPTION OF THE PREFERRED EMBODIMENT

The basic interactive, replay TV allows the user to specify which programs should be stored for future viewing. Current technology uses hard disk recorders to store the program content. In the future, hard disk recorders may be replaced by other media, including optical media and non-volatile random access memory.

Regardless of the type of storage media used, the basic problem is how to locate stored information at a later time.

The presently preferred embodiment provides an interactive, multimodal user interface for storing and retrieving information. The replay file system of the preferred embodiment captures information about each recorded program from the electronic program guide available via cable, satellite or internet.

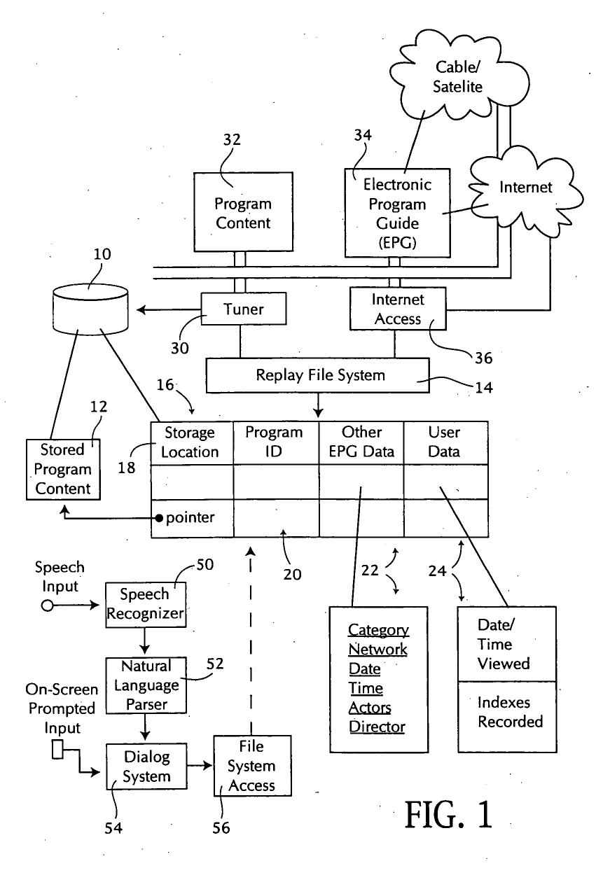

Referring to FIG. 1, a storage medium, such as a hard disk recorder medium, is illustrated at 10. The medium may be suitably partitioned to store program content (i.e., recorded broadcasts) together with a file system content access table used to retrieve information at a later date. The stored program content, depicted diagrammatically at 12, may be stored on the medium 10 according to any suitable physical file storage structure. For example, the content may be stored in blocks of a predetermined size at specified starting locations within the storage medium.

The replay file system 14 used to access the stored program content may also be stored on medium 10, or alternatively on some other storage device or memory. The file system structure is illustrated generally at 16. The structure includes a storage location record 18 for each program recorded. The information stored in each storage location record may constitute a pointer or address into the medium 10, showing where a particular stored program content resides.

Associated with each storage location record is a collection of additional data that is extracted from the electronic program guide, as will be more fully discussed below. This additional information may include, for example, a program identifier record 20, which may be the name of the program or other suitable label. In addition, other electronic program guide data may be stored in association with each program I.D. This other electronic program guide data is illustrated generally at 22 and may include such additional information as the program category (movie, news, weather, etc.) which network broadcasts the program content, the date and time of the broadcast, the actors starring in the broadcast, the director, and so forth. While this other electronic program guide data is not required to locate a recorded program if the program I.D. is known, the additional data is quite useful for enhancing interactive dialog between the user and the system when the program title or label is not known.

In addition, the replay file system may include associated user data records, illustrated at 24. These additional user data records may include, for example, the dates and times a particular program content was viewed, any recorded indexes the user has added to identify favorite parts of the program content, and so forth. The dates and times a program has been previously viewed can be used with a special feature of the system that mediates how contents of the medium may be selectively erased if the storage medium is nearing full. The user can record preferences in the user data record 24, indicating whether a particular recorded selection may be automatically erased after a predetermined time, or selectively erased only after it has been viewed, or never erased unless explicitly requested by the user.

An important aspect of the presently preferred replay file system is that the information used to locate recorded program content does not need to be explicitly written into the file system by the user. Rather, the system automatically extracts the appropriate identifying information from the electronic program guide resource that is available from the cable television or satellite broadcast infrastructure or over the Internet. The system automatically extracts electronic program guide information when the user records program content. The system does this through one of several mechanisms, depending on the particular embodiment.

In one embodiment, the tuner 30 tunes to a particular channel so that program content 32 may be viewed by the user or stored in storage medium 10. The tuner may be connected to a suitable cable television infrastructure or satellite infrastructure, for example. While the tuner is accessing the program content, it also obtains the electronic program guide data 34 from the same cable or satellite infrastructure. Tuner 30 passes the electronic program guide information to the replay file system 14, where the appropriate information is extracted and included in the file system record for the recorded program.

In an alternate embodiment, the electronic program guide information may be accessed from the Internet by a separate Internet access module 36. The Internet access module 36 can be coupled by cable modem to the internet or by telephone to an internet service provider. The internet access module obtains relevant electronic program guide information pertaining to the program being viewed and stores this information into the replay file system.

Once the stored program content and its associated file system information has been recorded, the user has a number of different options for retrieving this recorded information. The system employs a sophisticated speech-enabled, multimodal user interface whereby the user can use a combination of speech and/or on-screen prompted input (through remote control pushbuttons or the like) to request recorded information for replay.

The speech recognizer 50 receives spoken input through a suitable microphone which may be incorporated into the remote control, into a hands free device placed on a nearby coffee table or the like, or into the storage device or television set. Output from the speech recognizer is supplied to a natural language parser 52.

The natural language parser of the preferred embodiment is a goal-oriented parser that uses pre-defined goal-oriented grammars to identify different user requests. The goal-oriented grammars are structured to correspond with the electronic program guide information by which the stored program content has been indexed.

The system includes a dialog system 54 that responds to both output from the natural language parser 52 and also to on-screen prompted input. The dialog system has the ability to interact with the user, asking the user additional questions if necessary, in order to ascertain what stored program or programs the user is interested in retrieving. The dialog system is provided with a file system access module 56. This module accesses the replay file system records, to return all file system records that match the user's request.

For example, the user could speak into the system, “I would like to watch a movie.” The dialog system would use its file system access module to ascertain whether there are any movies recorded on the storage medium. If there are numerous movies stored on the system, for instance, the dialog system may prompt the user to narrow the request. The prompt can be supplied as an on-screen prompt or a synthesized speech prompt, or both. In this case, the prompt might ask the user what category of movie he or she is interested in viewing, listing the categories for which there are currently stored programs. The user could then select the category, and the system would continue to prompt the user until the user selected one program for viewing.

The dialog system 54 may also guide the user through other system operations, including the recording operation and other maintenance functions. The dialog system may be invoked, for example, when the disk is near full, and the system can determine by checking the electronic program guide data that the requested program will not fit on the remaining portion of the disk. The dialog system could prompt the user to either refrain from recording the program or to erase one or more previously recorded programs to make room.

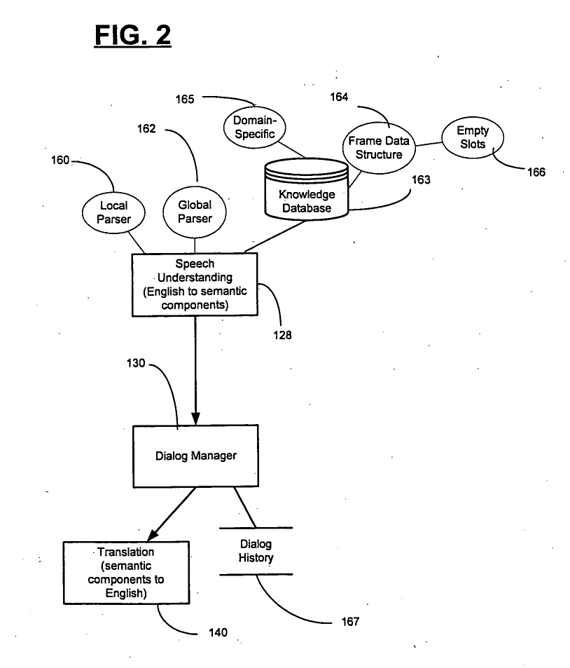

FIG. 2 depicts components of the natural language parser 52 in more detail. In particular, speech understanding module 128 includes a local parser 160 to identify predetermined relevant task-related fragments. Speech understanding module 128 also includes a global parser 162 to extract the overall semantics of the speaker's request.

The local parser 160 utilizes in the preferred embodiment small and multiple grammars along with several passes and a unique scoring mechanism to provide parse hypotheses. For example, the novel local parser 102 recognizes according to this approach phrases such as dates, names of people, and movie categories. If a speaker utters “record me a comedy in which Mel Brooks stars and is shown before January 23rd”, the local parser recognizes: “comedy” as being a movie category; “January 23rd” as a date; and “Mel Brooks” as an actor. The global parser assembles those items (movie category, date, etc.) together and recognizes that the speaker wishes to record a movie with certain constraints.

Speech understanding module 128 includes knowledge database 163 which encodes the semantics of a domain (i.e., goal to be achieved). In this sense, knowledge database 163 is preferably a domain-specific database as depicted by reference numeral 165 and is used by dialog manager 130 to determine whether a particular action related to achieving a predetermined goal is possible.

The preferred embodiment encodes the semantics via a frame data structure 164. The frame data structure 164 contains empty slots 166 which are filled when the semantic interpretation of global parser 162 matches the frame. For example, a frame data structure (whose domain is tuner commands) includes an empty slot for specifying the viewer-requested channel for a time period. If viewer 120 has provided the channel, then that empty slot is filled with that information. However, if that particular frame needs to be filled after the viewer has initially provided its request, then dialog manager 130 instructs computer response module 134 to ask viewer 120 to provide a desired channel.

The frame data structure 164 preferably includes multiple frames which each in turn have multiple slots. One frame may have slots directed to attributes of a movie, director, and type of movie. Another frame may have slots directed to attributes associated with the time in which the movie is playing, the channel, and so forth.

The following reference discusses global parsers and frames: R. Kuhn and R. D. Mori, Spoken Dialogues with Computers (Chapter 14: Sentence Interpretation), Academic Press, Boston (1998).

Dialog manager 130 uses dialog history data file 167 to assist in filling in empty slots before asking the speaker for the information. Dialog history data file 167 contains a log of the conversation which has occurred through the device of the present invention. For example, if a speaker utters “I'd like to watch another Marilyn Monroe movie,” the dialog manager 130 examines the dialog history data file 167 to check what movies the user has already viewed or rejected in a previous dialog exchange. If the speaker had previously rejected “Some Like It Hot”, then the dialog manager 130 fills the empty slot of the movie title with movies of a different title. If a sufficient number of slots have been filled, then the present invention will ask the speaker to verify and confirm the program selection. Thus, if any assumptions made by the dialog manager 130 through the use of dialog history data file 167 prove to be incorrect, then the speaker can correct the assumption.

The natural language parser 52 analyzes and extracts semantically important and meaningful topics from a loosely structured, natural language text which may have been generated as the output of an automatic speech recognition system (ASR) used by a dialogue or speech understanding system. The natural language parser 52 translates the natural language text input to a new representation by generating well-structured tags containing topic information and data, and associating each tag with the segments of the input text containing the tagged information. In addition, tags may be generated in other forms such as a separate list, or as a semantic frame.

Robustness is a feature of the natural language parser 52 as the input can contain grammatically incorrect English sentences, due to the following reasons: the input to the recognizer is casual, dialog style, natural speech can contain broken sentences, partial phrases, and the insertion, omission, or mis-recognition of errors by the speech recognizer even when the speech input is considered correct. The natural language parser 52 deals robustly with all types of input and extracts as much information as possible.

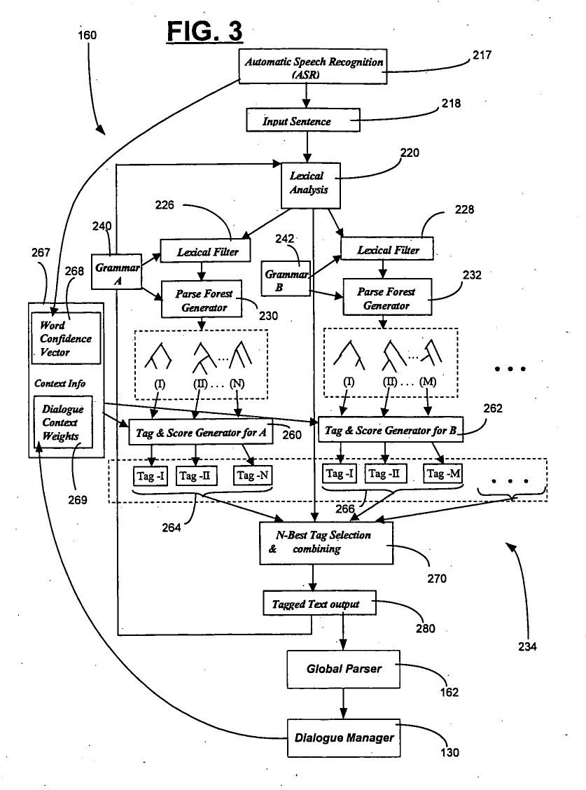

FIG. 3 depicts the different components of the local parser 160 of the natural language parser 24. The natural language parser 52 preferably utilizes generalized parsing techniques in a multi-pass approach as a fixed-point computation. Each topic is described as a context-sensitive LR (left-right and rightmost derivation) grammar, allowing ambiguities. The following are references related to context-sensitive LR grammars: A. Aho and J. D. Ullman, Principles of Compiler Design, Addison Wesley Publishing Co., Reading, Mass. (1977); and N. Tomita, Generalized LR Parsing, Kluwer Academic Publishers, Boston, Mass. (1991).

At each pass of the computation, a generalized parsing algorithm is used to generate preferably all possible (both complete and partial) parse trees independently for each targeted topic. Each pass potentially generates several alternative parse-trees, each parse-tree representing a possibly different interpretation of a particular topic. The multiple passes through preferably parallel and independent paths result in a substantial elimination of ambiguities and overlap among different topics. The generalized parsing algorithm is a systematic way of scoring all possible parse-trees so that the (N) best candidates are selected utilizing the contextual information present in the system.

Local parsing system 160 is carried out in three stages: lexical analysis 220; parallel parse-forest generation for each topic (for example, generators 230 and 232); and analysis and synthesis of parsed components as shown generally by reference numeral 234.

Lexical Analysis:

A speaker utters a phrase that is recognized by an automatic speech recognizer 217 which generates input sentence 218. Lexical analysis stage 220 identifies and generates tags for the topics (which do not require extensive grammars) in input sentence 218 using lexical filters 226 and 228. These include, for example, movie names; category of movie; producers; names of actors and actresses; and the like. A regular-expression scan of the input sentence 218 using the keywords involved in the mentioned exemplary tags is typically sufficient at this level. Also, performed at this stage is the tagging of words in the input sentence that are not part of the lexicon of particular grammar. These words are indicated using an X-tag so that such noise words are replaced with the letter “X”.

Parallel Parse-Forest Generation:

The natural language parser 52 uses a high-level general parsing strategy to describe and parse each topic separately, and generates tags and maps them to the input stream. Due to the nature of unstructured input text 218, each individual topic parser preferably accepts as large a language as possible, ignoring all but important words, dealing with insertion and deletion errors. The parsing of each topic involves designing context-sensitive grammar rules using a meta-level specification language, much like the ones used in LR parsing. Examples of grammars include grammar A 240 and grammar B 242. Using the present invention's approach, topic grammars 240 and 242 are described as if they were an LR-type grammar, containing redundancies and without eliminating shift and reduce conflicts. The result of parsing an input sentence is all possible parses based on the grammar specifications.

Generators 230 and 232 generate parse forests 250 and 252 for their topics. Tag-generation is done by synthesizing actual information found in the parse tree obtained during parsing. Tag generation is accomplished via tag and score generators 260 and 262 which respectively generate tags 264 and 266. Each identified tag also carries information about what set of input words in the input sentence are covered by the tag. Subsequently the tag replaces its cover-set. In the preferred embodiment, context information 267 is utilized for tag and score generations, such as by generators 260 and 262. Context information 267 is utilized in the scoring heuristics for adjusting weights associated with a heuristic scoring factor technique that is discussed below. Context information 267 preferably includes word confidence vector 268 and dialogue context weights 269. However, it should be understood that the parser 52 is not limited to using both word confidence vector 268 and dialogue context weights 269, but also includes using one to the exclusion of the other, as well as not utilizing context information 267.

Automatic speech recognition process block 217 generates word confidence vector 268 which indicates how well the words in input sentence 218 were recognized. Dialog manager 130 generates dialogue context weights 269 by determining the state of the dialogue. For example, dialog manager 130 asks a user about a particular topic, such as, what viewing time is preferable. Due to this request, dialog manager 130 determines that the state of the dialogue is time-oriented. Dialog manager 130 provides dialogue context weights 269 in order to inform the proper processes to more heavily weight the detected time-oriented words.

Synthesis of Tag-Components:

The topic spotting parser of the previous stage generates a significant amount of information that needs to be analyzed and combined together to form the final output of the local parser. The parser 52 is preferably as “aggressive” as possible in spotting each topic resulting in the generation of multiple tag candidates. Additionally in the presence of numbers or certain key-words, such as “between”, “before”, “and”, “or”, “around”, etc., and especially if these words have been introduced or dropped due to recognition errors it is possible to construct many alternative tag candidates. For example, an input sentence could have insertion or deletion errors. The combining phase determines which tags form a more meaningful interpretation of the input. The parser 52 defines heuristics and makes a selection based on them using a N-Best candidate selection process. Each generated tag corresponds to a set of words in the input word string, called the tag's cover-set.

A heuristic is used that takes into account the cover-sets of the tags used to generate a score. The score roughly depends on the size of the cover-set, the sizes in the number of the words of the gaps within the covered items, and the weights assigned to the presence of certain keywords. In the preferred embodiment, ASR-derived confidence vector and dialog context information are utilized to assign priorities to the tags. For example applying channel-tags parsing first potentially removes channel-related numbers that are easier to identify uniquely from the input stream, and leaves fewer numbers to create ambiguities with other tags. Preferably, dialog context information is used to adjust the priorities.

N-Best Candidates Selection

At the end of each pass, an N-best processor 270 selects the N-best candidates based upon the scores associated with the tags and generates the topic-tags, each representing the information found in the corresponding parse-tree. Once topics have been discovered this way, the corresponding words in the input can be substituted with the tag information. This substitution transformation eliminates the corresponding words from the current input text. The output 280 of each pass is fed-back to the next pass as the new input, since the substitutions may help in the elimination of certain ambiguities among competing grammars or help generate better parse-trees by filtering out overlapping symbols.

Computation ceases when no additional tags are generated in the last pass. The output of the final pass becomes the output of the local parser to global parser 162. Since each phase can only reduce the number of words in its input and the length of the input text is finite, the number of passes in the fixed-point computation is linearly bounded by the size of its input.

The following scoring factors are used to rank the alternative parse trees based on the following attributes of a parse-tree:

Number of terminal symbols.

Number of non-terminal symbols.

The depth of the parse-tree.

The size of the gaps in the terminal symbols.

ASR-Confidence measures associated with each terminal symbol.

Context-adjustable weights associated with each terminal and non-terminal symbol.

Each path preferably corresponds to a separate topic that can be developed independently, operating on a small amount of data, in a computationally inexpensive way. The architecture of the parser 52 is flexible and modular so incorporating additional paths and grammars, for new topics, or changing heuristics for particular topics is straight forward, this also allows developing reusable components that can be shared among different systems easily.

From the foregoing it will be seen that the system of the invention provides an interactive replay system with dynamically-built replay file system structure. Because the file system structure automatically extracts relevant information from the electronic program guide resources available via cable, satellite and/or internet, the system requires very little effort on the part of the user, while allowing a very rich interactive dialog to locate and replay stored information.

While the invention has been described in its presently preferred form, it will be understood that the invention is capable of modification without departing from the spirit of the invention as set forth in the appended claims.

1-12. (Cancelled)

13. A method for performing file management upon a group of entertainment media files, comprising:
processing an input speech utterance to extract first information about said group of entertainment media files;
maintaining a user data store containing data about a user's prior use of said group of entertainment media files;
based on said first information, extracting second information from the user data store;
using said first and second information to identify at least one specific file from said group of entertainment media files;
performing a management operation upon said specific file.

14. The method of claim 13 further comprising:
maintaining a program data store containing metadata about said group of entertainment media files;
based on said first information, extracting third information from said program data store; and
using said third information along with said first and second information to identify at least one specific file from said group of entertainment media files.

15. The method of claim 14 wherein said metadata is based on information selected from the group consisting of program title, program genre category, network, date, time, actors, directors and combinations thereof.

16. The method of claim 13 wherein said user data store contains data about a user's prior use selected from the group consisting of date viewed, time viewed, indexes recorded, and combinations thereof.

17. The method of claim 14 wherein said program data store is populated at least in part using electronic program guide data.

18. The method of claim 14 wherein said program data store is populated with data obtained from a broadcast source of entertainment media.

19. The method of claim 14 wherein said program data store is populated with data obtained from a network source of entertainment media.

20. The method of claim 18 wherein said broadcast source is a cable or satellite source.

21. The method of claim 19 wherein said network source is the internet.

22. The method of claim 13 wherein said step of processing an input speech utterance is performed using a speech recognizer and a natural language parser.

23. The method of claim 13 wherein said step of processing an input speech utterance includes using a dialog system to prompt a user to supply an utterance that contains said first information.

24. The method of claim 13 wherein said step of processing an input speech utterance includes using a dialog system to prompt a user to supply an utterance that expands upon said first information.

25. The method of claim 13 wherein said management operation is a media file retrieval operation.

26. The method of claim 13 wherein said management operation is a media file storage operation.
